(19) United States
(12) Patent Application Publication
(10) Pub. No.: US 2005/0071070 A1
(43) Pub. Date: Mar. 31, 2005

(54) Brake system with distributed electronic control units responsive to sensor input

(76) Inventors: Peter Nilsson, Orkelljunga (SE); Anders Lindqvist, Landkrona (SE)

Correspondence Address: ST. ONGE STEWARD JOHNSTON & REENS, LLC, 986 BEDFORD STREET, STAMFORD, CT, 06905-5619, US

(21) Appl. No.: 10/672,807

(22) Filed: Sep. 26, 2003

(51) Int. Cl. G06F 19/00

(52) U.S. Cl. 701/70; 701/48

(57) ABSTRACT

An electrically controlled braking system includes a plurality of brake components, at least one vehicle performance sensor, a central control unit receiving sensor signals from the at least one vehicle performance sensor and generating central control signals for controlling the plurality of brake components based on the received sensor signals, and a distributed electronic control unit receiving sensor signals from the at least one vehicle performance sensor and generating local control signals for controlling less than all of the plurality of brake components based on the received sensor signals.

### FIELD OF THE INVENTION

The present invention relates generally to an electrically controlled braking system which is intended for use with wheeled vehicles, and more particularly to a control network for such a braking system which incorporates distributed electronic control units in addition to a central control unit.

### BACKGROUND OF THE INVENTION

Traditional braking systems for motor vehicles include conventional hydraulic or pneumatic brakes associated with two or more wheels of the vehicle. Such conventional brakes are actuated by pressurized fluid or compressed air. When actuated, the brakes exert a force on a disk or drum which spins in conjunction with the wheel of the vehicle in order to create frictional forces which resist rotation of the wheel. Traditionally, control signals have been transmitted to each of the brake system's actuators mechanically, or by a hydraulic or pneumatic control circuit. However, it has more recently been proposed to employ a central control unit to generate electronic control signals and to use such electronic control signals to control actuation of a vehicle's brakes. This type of electronic control scheme has become even more prevalent in view of modern brake systems which now often include not only conventional hydraulic or pneumatic brake actuator functionality, but also supplemental electronic functions such as antilock protection (ABS) and/or electronic braking force distribution (EBV) between the front and rear axles.

U.S. Pat. No. 6,354,671 discloses a brake system in which electronic signals produced by a central controller in response to sensor input are used to at least partially control actuation of a vehicle's brakes. System redundancy is provided in the form of a back-up pneumatic control circuit. Should the electronic control unit malfunction, the braking system is controlled by the back-up pneumatic control circuit in much the same way as traditional brake systems operate.

U.S. Pat. No. 6,209,966 discloses a brake system which includes two electronic control units, which operate independently of each other, and which provide control signals in response to sensor input to a brake cylinder assigned to a wheel and a braking pressure modulator valve which is fluid-connected to the brake cylinder. The braking pressure modulator has a first electric actuating element, which can be activated by a first of the two control units, and a second electric actuating element which acts in the same direction when activated as the first electric actuating element. The second electric actuating element can be activated by the second electronic control unit at the same time as the first electric actuating element is being activated by the first electronic control unit. Thus, system redundancy is provided by providing two separate electronic control units, each of which controls one of two separate electric actuating elements associated with each wheel.

It has also been suggested to create a redundant electronic control system where two separate control networks are employed. Such a system employs one or more central control units provided to control, in response to sensor input, two or more brake assemblies, each having a brake actuator incorporating an electronic control unit. Central control unit or units is or are in electrical communication with the electronic control unit of each of the brake assemblies via at least two electronic control networks. All of the electronic control units of all brake assemblies are connected to each electronic control network. By providing such an arrangement, should one electronic control network fail, the other electronic control network would theoretically maintain control of all brake assemblies.

However, all three of the above-discussed prior art systems suffer from a number of disadvantages. One common disadvantage of all three systems is that the brake assemblies are essentially “dumb” in that no control signal generation is performed thereby. While it is true that in the last of the above-described systems each of the brake assemblies may be provided with an electronic control unit, the functionality of this electronic control unit is limited, for example, to processing (e.g. translating) control signals received from the central control unit in order to cause the brake to actuate. The electronic control units of the brake assemblies do not receive input from vehicle sensors, and do not generate (as opposed to manipulate) control signals. Thus, it is required for the central control unit in each of the above-described systems to process all sensor inputs and to generate all control signals for all brake assemblies. This is disadvantageous for several reasons.

It is often the case that the vehicle sensors are located remotely from the central control unit. As such, the time it takes for sensor signals to travel from the sensors to the central control unit, and then for the control signals, once generated, to travel from the central control unit to the brake assemblies may be relatively long, thereby causing the brake assemblies to respond to sensor input relatively slowly. It would be more desirable, particularly in situations where the vehicle sensors are located in closer proximity to the brake assemblies than to the central control unit, for the control signals to be generated at the brake assemblies themselves by “smart” brake assemblies.

Another disadvantage of requiring the central control unit to process all sensor inputs and to generate all control signals for all brake assemblies is that the processing of a large number of sensor signals and the generation of a large number of control signals by a single processor may take a relatively long period of time. This problem is exacerbated when the vehicle includes a large number of sensors and/or brake assemblies. It would be more desirable for control signals affecting only a single brake assembly and/or a group of brake assemblies to be generated at the brake assemblies themselves by “smart” brake assemblies, thereby freeing up the resources of the central control unit for the generation of control signals which affect many or all of the brake assemblies.

What is desired, therefore, is an electrically controlled braking system which is intended for use with wheeled vehicles, which allows brake assemblies to respond to sensor input relatively quickly, which does not require the central control unit to process all sensor inputs and to generate all control signals for all brake assemblies, which frees up the resources of the central control unit for the generation of control signals which affect many or all of the brake assemblies, and which in addition to a central control unit also includes “smart” brake assemblies capable of processing sensor input and generating control signals in response thereto.

### SUMMARY OF THE INVENTION

Accordingly, it is an object of the present invention to provide an electrically controlled braking system which is intended for use with wheeled vehicles.

Another object of the present invention is to provide an electrically controlled braking system having the above characteristics and which allows brake assemblies to respond to sensor input relatively quickly.

A further object of the present invention is to provide an electrically controlled braking system having the above characteristics and which does not require the central control unit to process all sensor inputs and to generate all control signals for all brake assemblies.

Still another object of the present invention is to provide an electrically controlled braking system having the above characteristics and which frees up the resources of the central control unit for the generation of control signals which affect many or all of the brake assemblies.

Yet a further object of the present invention is to provide an electrically controlled braking system having the above characteristics and which in addition to a central control unit also includes “smart” brake assemblies capable of processing sensor input and generating control signals in response thereto.

These and other objects of the present invention are achieved in one embodiment by provision of an electrically controlled braking system having a plurality of brake components, at least one vehicle performance sensor, a central control unit receiving sensor signals from the at least one vehicle performance sensor and generating central control signals for controlling the plurality of brake components based on the received sensor signals, and a distributed electronic control unit receiving sensor signals from the at least one vehicle performance sensor and generating local control signals for controlling less than all of the plurality of brake components based on the received sensor signals.

In some embodiments, the distributed electronic control unit generates local control signals for controlling only one of the plurality of brake components. In other embodiments, the distributed electronic control unit generates local control signals for controlling at least two of the plurality of brake components located on a common axle of the vehicle.

In some embodiments, the at least one vehicle performance sensor comprises a plurality of vehicle performance sensors, at least one of which provides sensor signals to both the central control unit and the distributed electronic control unit. In certain embodiments, the at least one vehicle performance sensor comprises a plurality of vehicle performance sensors, at least one of which provides sensor signals only to the central control unit. In some embodiments, the at least one vehicle performance sensor comprises a plurality of vehicle performance sensors, at least one of which provides sensor signals only to the distributed electronic control unit.

In certain embodiments, a second distributed electronic control unit is provided and the at least one vehicle performance sensor comprises a plurality of vehicle performance sensors, at least one of which provides sensor signals to the central control unit, the distributed electronic control unit and the second distributed electronic control unit. In some embodiments, a second distributed electronic control unit is provided and the at least one vehicle performance sensor comprises a plurality of vehicle performance sensors, at least one of which provides sensor signals to the distributed electronic control unit and the second distributed electronic control unit.

In certain embodiments, at least one of the vehicle performance sensors comprises part of one of the plurality of brake components. In some embodiments, at least one of the vehicle performance sensors is separate from the plurality of brake components. In certain embodiments, a manual input is provided for overriding the central control signals and the local control signals

In another embodiment of the present invention, a brake system for a heavy vehicle includes a plurality of brake components, at least one vehicle performance sensor, and a plurality of distributed electronic control units, each of the plurality of distributed electronic control units being associated with a single one of the plurality of brake components. Each of the plurality of distributed electronic control units receives sensor signals from the at least one vehicle performance sensor and generates local control signals for controlling the one of the plurality of brake components with which that particular distributed electronic control unit is associated based on the received sensor signals.

In some embodiments, the system further includes a central control unit receiving sensor signals from the at least one vehicle performance sensor and generating central control signals for controlling the plurality of brake components based on the received sensor signals.

In a further embodiment of the present invention, a brake system for a heavy vehicle includes a plurality of brake components, the plurality of brake components comprising a first subset of brake components and a second subset of brake components, at least one vehicle performance sensor, a central control unit receiving sensor signals from the at least one vehicle performance sensor and generating central control signals for controlling the first subset of brake components and the second subset of brake components based on the received sensor signals, and a distributed electronic control unit receiving sensor signals from the at least one vehicle performance sensor and generating local control signals for controlling the first subset of brake components based on the received sensor signals.

In some embodiments, the first subset of brake components comprises a single brake component. In other embodiments, the first subset of brake components comprises a plurality of brake components. In certain of these embodiments, the plurality of brake components comprising the first subset of brake components are disposed on a common axle of the vehicle.

In some embodiments, the system further includes a second distributed electronic control unit receiving sensor signals from the at least one vehicle performance sensor and generating local control signals for controlling the second subset of brake components based on the received sensor signals. In certain of these embodiments, the second subset of brake components comprises a single brake component. In others of these embodiments, the second subset of brake components comprises a plurality of brake components. In certain of these embodiments, the plurality of brake components comprising the second subset of brake components are disposed on a common axle of the vehicle.

The invention and its particular features and advantages will become more apparent from the following detailed description considered with reference to the accompanying drawings.

### BRIEF DESCRIPTION OF THE DRAWINGS

FIG. 1 is a schematic view of an electrically controlled braking system in accordance with an embodiment of the present invention;

FIG. 2 is a schematic view of an electrically controlled braking system in accordance with another embodiment of the present invention; and

FIG. 3 is a block diagram illustrating operation the electrically controlled braking systems of FIGS. 1 and 2.

### DETAILED DESCRIPTION OF AN EMBODIMENT OF THE INVENTION

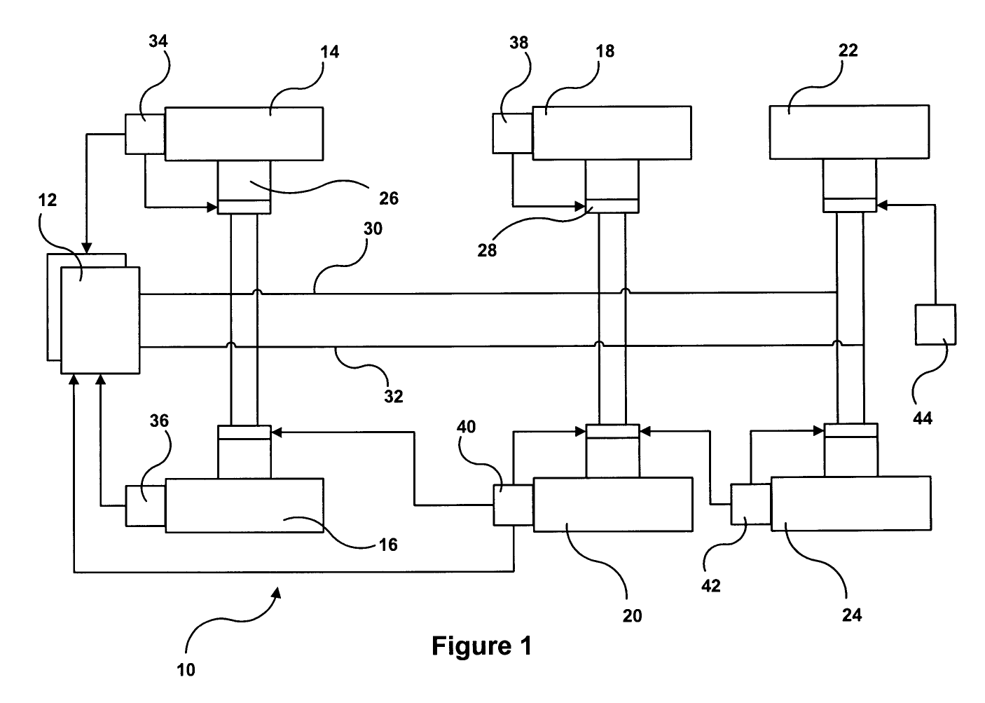

Referring first to FIG. 1, an electrically controlled braking system 10 in accordance with the present invention is shown. Braking system 10 includes at least one central control unit 12 which generates central control signals. Braking system 10 also includes a plurality of brake components 14, 16, 18, 20, 22, 24. While six brake components 14, 16, 18, 20, 22, 24 are shown in FIG. 1, it should be understood that braking system 10 may include a greater or lesser number of brake components.

Each of brake components 14, 16, 18, 20, 22, 24 is responsive to the central control signals generated by control unit(s) 12. More particularly, each of brake components 14,16, 18, 20, 22, 24 includes a brake actuator 26 incorporating a distributed electronic control unit 28 which distributed electronic control unit 28 causes brake actuator 26 to operate in response to the central control signals generated by central control unit(s) 12. As this central control aspect of such electronically controllable brake components are known in the art, a detailed discussion of the operation thereof is not presented herein. Each of brake components 14,16,18, 20, 22, 24 may be actuated by electrical force, hydraulic force, pneumatic force, combinations of these, and/or by any other appropriate force.

Braking system 10 includes at least one control network for transmitting central control signals from central control unit(s) 12 to each of brake components 14, 16, 18, 20, 22, 24. Numerous configurations for the control network(s) are possible. For example, a single control network may be provided. Alternately, in order to provide system redundancy multiple control networks may be provided. In braking system 10 shown in FIG. 1, two control networks 30, 32 are provided, with each of brake components 14, 16, 18, 20, 22, 24 being connected to each control network 30, 32. Both control networks 30, 32 may transmit central control signals generated by a single central control unit 12, or each control network 30, 32 may transmit central control signals generated by a different of two central control units 12.

In addition to central control signals being generated by central control unit(s) 12, local control signals are generated by each of distributed electronic control units 28 which local control signals are used to control only one vehicle actuator 26 rather than controlling all vehicle actuators 26, as is the case with central control unit(s) 12. This allows certain functions of vehicle actuators 26 which do not affect operation of others of vehicle actuators 26 to be controlled locally by distributed electronic control units 28, while reserving control by central control unit(s) 12 only for those circumstances where coordination of multiple vehicle actuators 26 is required. Such localized distributed control provides several advantages over completely centralized control, including quicker response times (e.g., due to shorter electrical signal travel and reduced processing by the central controller) and more reliable system operation (e.g., due to system redundancy).

Thus, in some cases, it may be desired that particular functions of actuators 26 be controlled completely locally, in which cases actuation signals transmitted to actuators 26 are based solely on sensor signals received by distributed electronic control units 28. In other cases it may be desired that particular functions of actuators 26 be controlled solely by central control unit(s) 12, in which cases, actuation signals transmitted to actuators 26 are based solely on central control signals received by distributed electronic control units 28 from central control unit(s) 12. In still other cases, it may be desired that particular functions of actuators 26 be controlled by both distributed electronic control units 28 and central control unit(s) 12. In these cases, actuation signals transmitted to actuators 26 are based on both central control signal received by distributed electronic control units 28 from central control unit(s) 12 and sensor signals received by distributed electronic control units 28. Any conflicts between central control signal received by distributed electronic control units 28 from central control unit(s) 12 and local control signals generated by distributed electronic control units 28 may be resolved by distributed electronic control units 28 before actuation signals are transmitted to actuators 26.

As alluded to above, system 10 includes a plurality of vehicle sensors which detect and produce sensor signals indicative of one or more operating parameters of the vehicle. Examples of such vehicle sensors include wheel speed sensors, pitch sensors, vehicle height sensors, vehicle weight sensors, and many others. Sensor signals are processed by central control unit(s) 12 and/or distributed electronic control units 28 according to various control schemes which may be stored thereon in order to generate central control signals and/or local control signals. As the processing of sensor signals in order to generate control signals is known in the art, such is not discussed herein in detail.

Depending upon the particular vehicle parameter which is being sensed and whether central and/or local control of brake components 14, 16, 18, 20, 22, 24 is desired with respect to such parameter, sensors may be connected in various ways within system 10. In cases where control of a single brake component is desired both centrally and locally based upon the input of a sensor, that sensor 34 may provide sensor signals to both central control unit(s) 12 and a single distributed electronic control unit 28. In cases where control of a single or multiple brake components is desired only centrally based upon the input of a sensor, that sensor 36 may provide sensor signals only to central control unit(s) 12. In cases where control of a single brake component is desired only locally based upon the input of a sensor, that sensor 38 may provide sensor signals only to a single distributed electronic control unit 28. In cases where control of multiple brake components is desired both centrally and locally based upon the input of a sensor, that sensor 40 may provide sensor signals to both central control unit(s) 12 and multiple distributed electronic control units 28. In cases where control of multiple brake components is desired only locally based upon the input of a sensor, that sensor 42 may provide sensor signals only to multiple distributed electronic control units 28. Each sensor may comprise a part of a brake component, as is the case with sensors 34, 36, 38, 40, 42 shown in FIG. 1, or may be separate therefrom as is the case with sensor 44 also shown in FIG. 1.

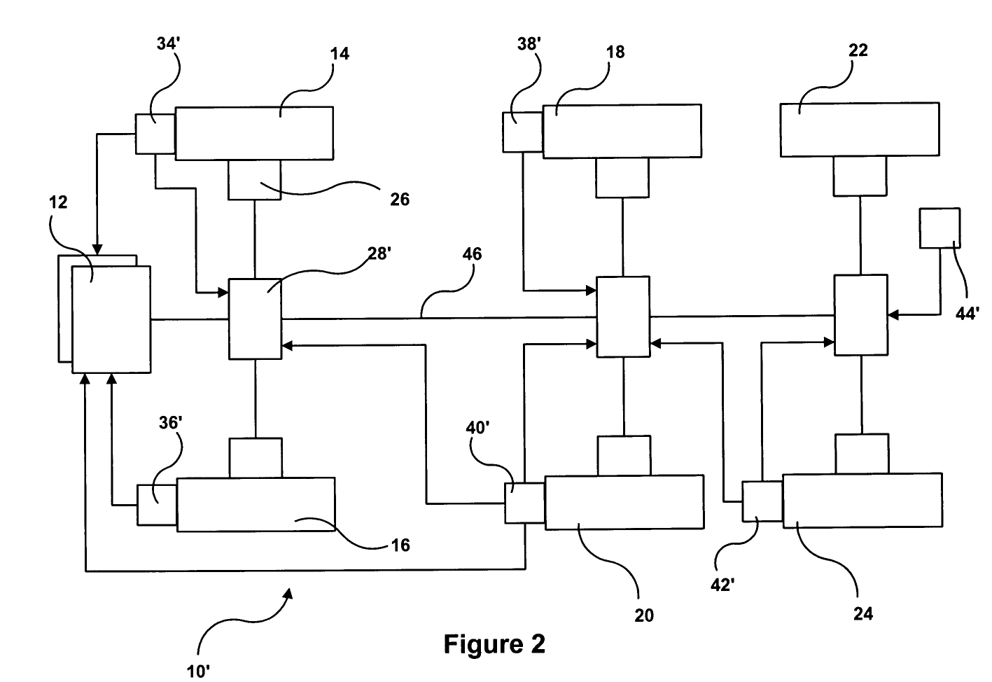

Referring now to FIG. 2, rather than each of distributed electronic control units 28 being associated with a single brake component 14, 16, 18, 20, 22, 24, distributed electronic control units 28′ may be associated with a subset of brake component 14, 16, 18, 20, 22, 24. In the exemplary embodiment shown in FIG. 2, each distributed electronic control unit 28′ is associated with a pair of actuators on a single vehicle axle, and is connected to central control unit(s) 12 via a single control network 46.

As is the case with the embodiment shown in FIG. 1, depending upon the particular vehicle parameter which is being sensed and whether central and/or local control of brake components 14, 16, 18, 20, 22, 24 is desired with respect to such parameter, sensors may be connected in various ways within system 10′ shown in FIG. 2. In cases where control of a single subset of brake components is desired both centrally and locally based upon the input of a sensor, that sensor 34′ may provide sensor signals to both central control unit(s) 12 and a single distributed electronic control unit 28′. In cases where control of a single or multiple subsets of brake components is desired only centrally based upon the input of a sensor, that sensor 36′ may provide sensor signals only to central control unit(s) 12. In cases where control of a single subset of brake components is desired only locally based upon the input of a sensor, that sensor 38′ may provide sensor signals only to a single distributed electronic control unit 28′. In cases where control of multiple subsets of brake components is desired both centrally and locally based upon the input of a sensor, that sensor 40′ may provide sensor signals to both central control unit(s) 12 and multiple distributed electronic control units 28′. In cases where control of multiple subsets of brake components is desired only locally based upon the input of a sensor, that sensor 42′ may provide sensor signals only to multiple distributed electronic control units 28′. Each sensor may comprise a part of a brake component, as is the case with sensors 34′, 36′, 38′, 40′, 42′ shown in FIG. 2, or may be separate therefrom as is the case with sensor 44′ also shown in FIG. 2.

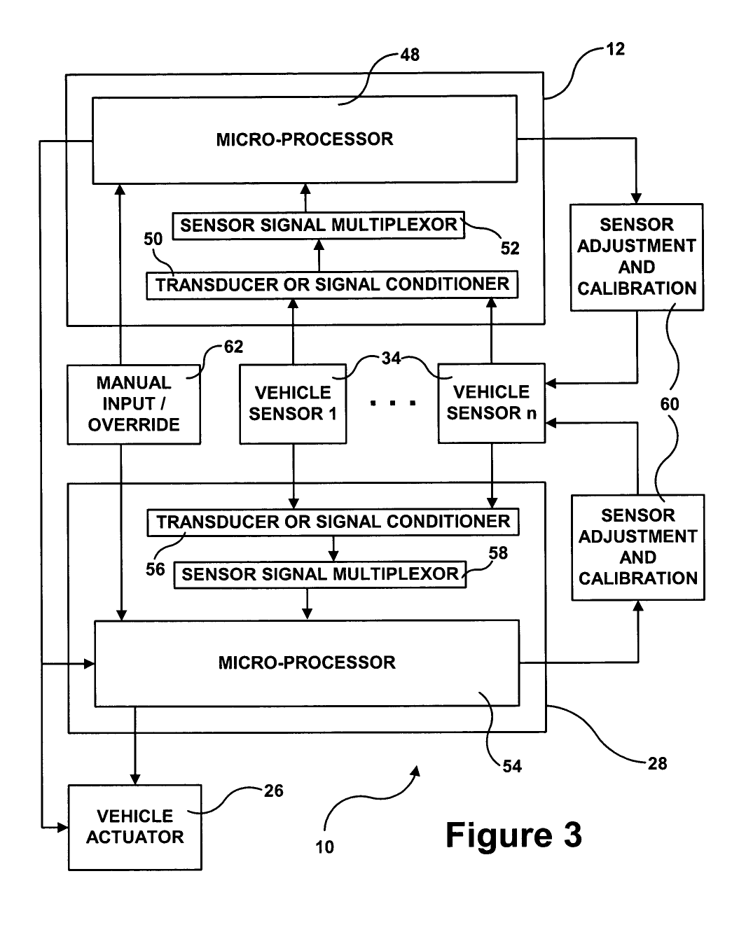

Referring now to FIG. 3, each central control unit 12 includes a microprocessor 48 which is employed to process sensor signals received from sensors 34 and generate central control signals. Because the signals produced by sensors 34 may have one of a variety of different formats, a transducer or signal conditioner 50 may be provided for translating the format of the signals into a format useable by microprocessor 48. Also, because a plurality of sensor signals may be transmitted simultaneously by sensors 34, a sensor signal multiplexor 52 may be provided for avoiding conflicts between sensor signals. The conditioned and multiplexed signals are then transmitted to microprocessor 48. Each distributed electronic control unit 28 similarly includes a microprocessor and may include a transducer or signal conditioner 56 and/or a sensor signal multiplexor 58.

System 10 may allow microprocessor(s) 48 and/or microprocessors 54 to control operation of sensors 34 via a sensor adjustment and calibration signal 60 or the like. For example, under certain conditions it may be desirable for vehicle sensors 34 to provide more detailed data than is typically provided or to provide data more or less often than is typical.

System 10 may include the ability to receive manual input and/or override commands 62 from the vehicle operator in order to manually control vehicle actuators 26 and/or override commands issued by microprocessor(s) 48 and/or microprocessors 54. Such manual input and/or override commands 62 may be fed to microprocessor(s) 48 and/or microprocessors 54 for transmission thereby to actuators 26, or may be fed directly to actuators 26 without passing through microprocessor(s) 48 and/or microprocessors 54.

Brake components 14, 16, 18, 20, 22, 24 are in communication with some type of energy supply for supplying power for operating the components. The energy supply may comprise, for example, a pressurized air reservoir or a battery for supplying power in the form of pneumatic power or electrical power respectively. In certain embodiments, the same centralized energy supply supplies power to all components centrally controlled by system 10. In other embodiments, various components centrally controlled by system 10 may be supplied power by various supplies of energy.

In addition to controlling standard braking operations, central control unit(s) 12 and/or distributed electronic control units 28 may control various additional braking functions, such as antilock brake systems (ABS) and electronic braking force distribution (EBV) systems, as well as other vehicle systems, such as vehicle suspension and dynamic stability systems.

The present invention, therefore, provides an electrically controlled braking system which is intended for use with wheeled vehicles, which allows brake assemblies to respond to sensor input relatively quickly, which does not require the central control unit to process all sensor inputs and to generate all control signals for all brake assemblies, which frees up the resources of the central control unit for the generation of control signals which affect many or all of the brake assemblies, and which in addition to a central control unit also includes “smart” brake assemblies capable of processing sensor input and generating control signals in response thereto.

Although the invention has been described with reference to a particular arrangement of parts, features and the like, these are not intended to exhaust all possible arrangements or features, and indeed many other modifications and variations will be ascertainable to those of skill in the art.

1. A brake system for a heavy vehicle, comprising:
a plurality of brake components;
at least one vehicle performance sensor;
a central control unit receiving sensor signals from said at least one vehicle performance sensor and generating central control signals for controlling said plurality of brake components based on the received sensor signals; and
a distributed electronic control unit receiving sensor signals from said at least one vehicle performance sensor and generating local control signals for controlling less than all of said plurality of brake components based on the received sensor signals.

2. The brake system of claim 1 wherein said distributed electronic control unit generates local control signals for controlling only one of said plurality of brake components.

3. The brake system of claim 1 wherein said distributed electronic control unit generates local control signals for controlling at least two of said plurality of brake components located on a common axle of the vehicle.

4. The brake system of claim 1 wherein said at least one vehicle performance sensor comprises a plurality of vehicle performance sensors, at least one of which provides sensor signals to both said central control unit and said distributed electronic control unit.

5. The brake system of claim 1 wherein said at least one vehicle performance sensor comprises a plurality of vehicle performance sensors, at least one of which provides sensor signals only to said central control unit.

6. The brake system of claim 1 wherein said at least one vehicle performance sensor comprises a plurality of vehicle performance sensors, at least one of which provides sensor signals only to said distributed electronic control unit.

7. The brake system of claim 1 further comprising a second distributed electronic control unit and wherein said at least one vehicle performance sensor comprises a plurality of vehicle performance sensors, at least one of which provides sensor signals to said central control unit, said distributed electronic control unit and said second distributed electronic control unit.

8. The brake system of claim 1 further comprising a second distributed electronic control unit and wherein said at least one vehicle performance sensor comprises a plurality of vehicle performance sensors, at least one of which provides sensor signals to said distributed electronic control unit and said second distributed electronic control unit.

9. The system of claim 1 wherein at least one of said vehicle performance sensors comprises part of one of said plurality of brake components.

10. The system of claim 1 wherein at least one of said vehicle performance sensors is separate from said plurality of brake components.

11. The brake system of claim 1 further comprising a manual input for overriding the central control signals and the local control signals

12. A brake system for a heavy vehicle, comprising:
a plurality of brake components;
at least one vehicle performance sensor; and
a plurality of distributed electronic control units, each of said plurality of distributed electronic control units being associated with a single one of said plurality of brake components, each of said plurality of distributed electronic control units receiving sensor signals from said at least one vehicle performance sensor and generating local control signals for controlling the one of said plurality of brake components with which that particular distributed electronic control unit is associated based on the received sensor signals.

13. The system of claim 12 further comprising a central control unit receiving sensor signals from said at least one vehicle performance sensor and generating central control signals for controlling said plurality of brake components based on the received sensor signals.

14. A brake system for a heavy vehicle, comprising:
a plurality of brake components, said plurality of brake components comprising a first subset of brake components and a second subset of brake components;
at least one vehicle performance sensor;
a central control unit receiving sensor signals from said at least one vehicle performance sensor and generating central control signals for controlling the first subset of brake components and the second subset of brake components based on the received sensor signals; and
a distributed electronic control unit receiving sensor signals from said at least one vehicle performance sensor and generating local control signals for controlling the first subset of brake components based on the received sensor signals.

15. The system of claim 14 wherein the first subset of brake components comprises a single brake component.

16. The system of claim 14 wherein the first subset of brake components comprises a plurality of brake components.

17. The system of claim 16 wherein the plurality of brake components comprising the first subset of brake components are disposed on a common axle of the vehicle.

18. The system of claim 14 further comprising a second distributed electronic control unit receiving sensor signals from said at least one vehicle performance sensor and generating local control signals for controlling the second subset of brake components based on the received sensor signals.

19. The system of claim 17 wherein the second subset of brake components comprises a single brake component.

20. The system of claim 17 wherein the second subset of brake components comprises a plurality of brake components.

21. The system of claim 20 wherein the plurality of brake components comprising the second subset of brake components are disposed on a common axle of the vehicle.
